(19) United States
(12) Patent Application Publication
(10) Pub. No.: US 2016/0285062 A1
(43) Pub. Date: Sep. 29, 2016

(54) SEPARATOR AND SECONDARY BATTERY USING THE SAME

(71) Applicant: Samsung SDI Co., LTD., Yongin-si (KR)

(72) Inventors: YUNKYUNG JO, Yongin-si (KR); CHANJUNG KIM, Yongin-si (KR); IHN KIM, Yongin-si (KR); YOUNGSU KIM, Yongin-si (KR); SUKJUNG SON, Yongin-si (KR); NARAE PARK, Yongin-si (KR); JUNGJIN MOON, Yongin-si (KR); HYEJIN YOON, Yongin-si (KR); JUNGRAN LEE, Yongin-si (KR); JUNGMO JO, Yongin-si (KR)

(21) Appl. No.: 15/078,957

(22) Filed: Mar. 23, 2016

(30) Foreign Application Priority Data
Mar. 27, 2015 (KR) 10-2015-0043480

(51) Int. Cl. H01M 2/16; H01M 10/0525; H01M 10/04

(52) U.S. Cl. CPC H01M 2/168; H01M 2/166; H01M 10/0431; H01M 10/0525

(57) ABSTRACT

A separator includes a substrate layer that is porous and an adhesion layer on at least one side of the substrate layer, where inorganic substances are embedded in the separator. A secondary battery includes: an electrode assembly including a first electrode plate, a second electrode plate, and the separator between the first electrode plate and the second electrode plate, the first electrode plate, the second electrode plate and the separator being stacked, and at least one electrode tab being withdrawn to a side of the electrode assembly; and a case receiving the electrode assembly.

### CROSS-REFERENCE TO RELATED APPLICATION

This application claims priority to and the benefit of Korean Patent Application No. 10-2015-0043480, filed on Mar. 27, 2015, in the Korean Intellectual Property Office, the entire content of which is incorporated herein by reference in its entirety.

### BACKGROUND

1. Field

Embodiments of the present disclosure relate to a separator and a secondary battery, and, for example, to a separator capable of increasing lifespan and a secondary battery using the same.

2. Description of the Related Art

In recent years, interest in energy storage technology has increased. Much effort is being made into the research and development of batteries as the field of application has expanded to cell phones, camcorders, laptops and personal computers (PCs), and even electric vehicles. Electrochemical devices are in a field where the most attention is made, and where, for example, the development of a secondary battery is actively progressing.

A secondary battery is a chemical battery using reversible mutual conversion of chemical energy and electrical energy, and is capable of repeating charging and discharging cycles. Secondary batteries can be divided into, for example, a Ni-MH secondary battery and a lithium secondary battery. Examples of the lithium secondary battery may include a lithium metal secondary battery, a lithium ion secondary battery, a lithium polymer secondary battery, and a lithium ion polymer secondary battery.

The lithium secondary battery may have features such that the operating voltage is high and it has a high energy density as compared to the Ni-MH battery, which uses an aqueous solution electrolyte. Although lithium secondary batteries are manufactured by many companies, there have been many different safety issues reported.

Since securing safety as well as safety evaluation of a battery should be some of the most important factors, safety regulations for lithium secondary batteries are strictly enforced. Lithium ion batteries and lithium ion polymer batteries currently being manufactured are using polyolefin type (or kind) of separators in order to prevent or reduce short circuit of an anode and a cathode.

### SUMMARY

Embodiments of the present disclosure are directed toward a separator capable of improving a heat resisting property and life by forming adhesion layers on both sides of a substrate layer of the separator where inorganic substances are embedded, and embodiments of the present disclosure are directed toward a secondary battery using the same.

A separator may include a substrate layer that is porous and an adhesion layer on at least one side of the substrate layer, wherein inorganic substances are embedded in the separator.

The inorganic substances may be located inside the substrate layer.

The separator may further include inorganic layers on both sides of the substrate layer, and the inorganic substances may be embedded in the inorganic layers.

The substrate layer may include any one selected from the group consisting of polyethylene (PE), polypropylene (PP), and any mixture thereof.

The inorganic substances may be embedded in the substrate layer, and pores of the substrate layer where the inorganic substances are embedded may have a size in a range of 10 to 200 nm.

An air permeability of the separator may be in a range of 150 to 300 sec/100 cc.

The adhesion layer may include a polymer.

The adhesion layer may include polyvinylidene fluoride (PVDF) or acrylate.

The adhesion layer may include adhesion layers on both sides of the substrate layer, and a sum of thicknesses of the adhesion layers on both sides of the substrate layer may be in a range of 1 to 6 μm.

A secondary battery may include an electrode assembly including a first electrode plate, a second electrode plate, and a separator between the first electrode plate and the second electrode plate, the first electrode plate, the second electrode plate and the separator being stacked, and at least one electrode tab being withdrawn to a side of the electrode assembly, and a case receiving the electrode assembly, where the separator is porous, inorganic substances are embedded in the separator, and the separator includes a substrate layer including an adhesion layer on at least one side of the substrate layer.

The inorganic substances may be located inside the substrate layer.

The separator may further include inorganic layers on both sides of the substrate layer, and the inorganic substances may be embedded in the inorganic layers.

### BRIEF DESCRIPTION OF THE DRAWINGS

Example embodiments will now be described more fully hereinafter with reference to the accompanying drawings; however, subject matter disclosed herein may be embodied in different forms and should not be construed as being limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. In the present disclosure, it will be understood that when an element is referred to as being “between” two elements, it can be the only element between the two elements, or one or more intervening elements may also be present. Like reference numerals refer to like elements throughout.

FIG. 1 is a perspective view illustrating a separator according to a first embodiment.

FIG. 2 is a cross-sectional view taken along the line A-A′ of FIG. 1.

FIG. 3 is a perspective view illustrating a separator according to another embodiment.

FIG. 4 is cross-sectional view taken along the line B-B′ of FIG. 3.

FIG. 5A is an exploded perspective view illustrating an embodiment of an electrode assembly.

FIG. 5B is a perspective view illustrating an embodiment of an electrode assembly in a state of being wound.

FIG. 6 is a perspective view illustrating an embodiment of a secondary battery.

### DETAILED DESCRIPTION

In the following detailed description, only certain example embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, it will be understood that when an element or layer is referred to as being “on”, “connected to” or “coupled to” another element or layer, it can be directly on, connected or coupled to the other element or layer or it can be indirectly on, connected or coupled to the other element or layer with one or more intervening elements or layers interposed therebetween. In contrast, when an element or layer is referred to as being “directly on,” “directly connected to” or “directly coupled to” another element or layer, there are no intervening elements or layers present between the element or layer and the other element or layer. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the spirit or scope of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below, depending upon the point of view. The device may be otherwise oriented (e.g., rotated 90 degrees or at other orientations) and the spatially relative descriptors used herein interpreted accordingly.

The terminology used herein is for the purpose of describing particular embodiments only and is not intended to be limiting of the present disclosure. As used herein, the singular forms, “a”, “an” and “the” are intended to include the plural forms as well, unless the context clearly indicates otherwise. It will be further understood that the terms “includes” and/or “including”, when used in this specification, specify the presence of the stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “substantially,” “about,” and similar terms are used as terms of approximation and not as terms of degree, and are intended to account for the inherent deviations in measured or calculated values that would be recognized by those of ordinary skill in the art. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112(a), and 35 U.S.C. §132(a).

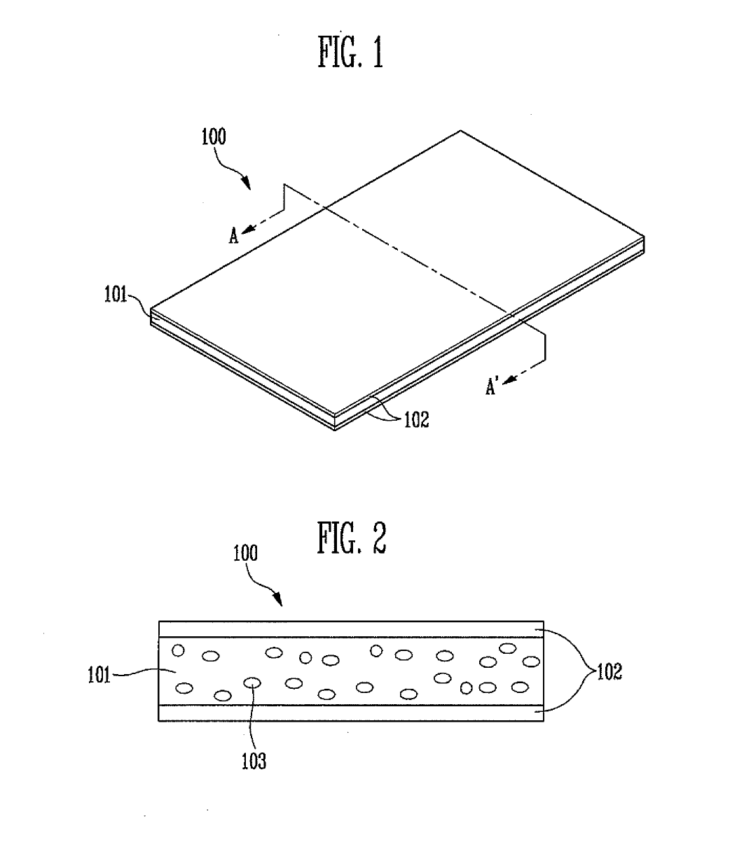

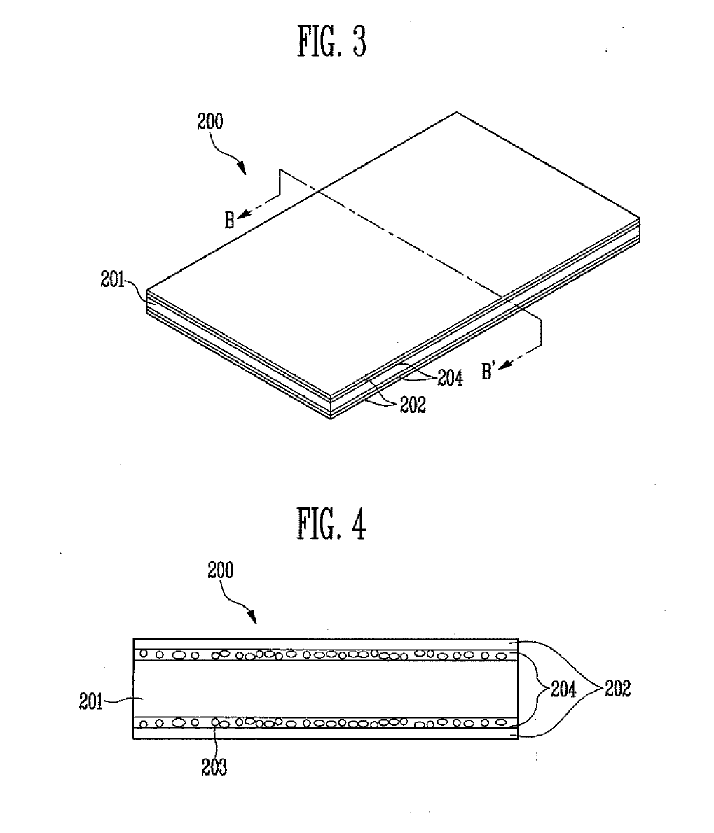

FIG. 1 is a perspective view illustrating a separator according to a first embodiment. FIG. 2 is a cross-sectional view taken along the line A-A′ of FIG. 1.

Referring to FIGS. 1 and 2, a separator 100 according to a first embodiment may include a substrate layer 101 that is porous and an adhesion layer 102 on or formed on at least one surface of the substrate layer 101. Inorganic substances 103 may be embedded in the separator 100 (e.g., may be embedded in the substrate layer 101). For example, the inorganic substances 103 may be located inside the substrate layer 101. The inorganic substances 103 may be mixed in the substrate layer 101, and as a result, there may be a single layer formed. For example, a single layer may include both the substrate layer 101 and the inorganic substances 103.

Generally, the separator 100 may include or be formed of a porous layer for smooth or substantially smooth transfer of lithium ions. The separator 100 may include or be formed of a polyolefin type (or kind) of material to secure safety of the secondary battery. The substrate may be coated. The coating on the substrate may include or contain inorganic substances such as aluminum. However, when characteristics of the separator including a substrate coated with inorganic substances were tested, it was determined that the long life performance of the separator could be improved.

In order to enhance the long life performance of a secondary battery, the porosity or pore size of the substrate could be increased. However, increasing the porosity or pore size of the substrate may be disadvantageous from a safety perspective due to heat exposure and the like.

In order to improve both the safety and the long life performance at the same or substantially the same time, the inorganic substances 103 may be embedded in the substrate layer 101 of the separator 100. The adhesion layers 102 may be included or formed to increase adhesiveness of the separator 100 with electrode plates on or formed on at least one side (or both sides) of the separator 100.

The substrate layer 101 of the separator 100 may be any one selected from polyethylene, polypropylene, and any mixture thereof. The inorganic substances 103 embedded in the substrate layer 101 may include Al₂O₃, TiO₂, SiO₂, Ba, or the like.

The substrate layer 101 may be porous. However, the pore size of the substrate layer 101 where the inorganic substances 103 are embedded may be greater than the pore size of the substrate layer 101 which may be porous (and which does not include the inorganic substances 103). The pore size of the substrate layer 101 where the inorganic substances 103 are embedded may be in a range of 10 to 200 nm. An air permeability of the separator where the inorganic substances are embedded may be in a range of 150 to 300 sec/100 cc. A non-restrictive example of the method of measuring air permeability is as follows: After manufacturing 5 samples by cutting the separator manufactured at 5 different points, time required for air 100 cc to pass through the separator was measured in each of the samples using air permeability tester (Asahi Seiko Co. Ltd.). The time was measured 5 times, respectively, and an average value thereof was calculated, thereby measuring air permeability.

If the pore size of the substrate layer 101 where the inorganic substances 103 are embedded is less than 10 nm and the air permeability of the separator is less than 150 sec/100 cc, there may not be any particular difference from (e.g., there may not be a noticeable improvement over) the substrate layer 101 where the inorganic substances 103 are not embedded. Therefore, it may be difficult to improve long life and the heat-resisting property of a substrate layer 101 where the pore size is less than 10 nm and the air permeability of the separator is less than 150 sec/100 cc. If the pore size of the substrate layer 101 where the inorganic substances 103 are embedded exceeds 200 nm and the air permeability of the separator exceeds 300 sec/100 cc, it may be difficult to maintain the mechanical property of the substrate layer, and due to an excessively large pore size, there may be an increased risk of internal short-circuit at the time of charging/discharging the battery. As such, the substrate layer 101 where the inorganic substances 103 are embedded may implement long life and heat-resisting property by including large pores at or on an inside thereof.

The pore size and the air permeability of the separator 101 where the inorganic substances 103 are embedded may be important factors for controlling ion conductance. Therefore, by allowing proper pore size and air permeability, performance of a secondary battery including the substrate layer 101 may be enhanced.

The adhesion layers 102 on or formed on both sides of the substrate layer 101 where the inorganic substances 103 are embedded may include or be formed of polymers. For example, but without limitation thereto, the adhesion layers 102 may include or be formed of polyvinylidene fluoride (PVDF) or acrylate. As such, in order to facilitate transfer of lithium ions, the adhesion layers 102 may be porous, and a sum of the adhesion layers 102 on or formed on both sides of the substrate layer 101 may have a thickness in a range of 1 to 6 μm.

If the adhesion layers 102 are formed to be less than 1 μm, it may not be easy to attach electrode plates on both sides of the substrate layer 101 when manufacturing a secondary battery. If the adhesion layers 102 exceed 6 μm, the transfer of lithium ions between the electrode plates and the substrate layer 101 of the separator 100 may be restricted or reduced.

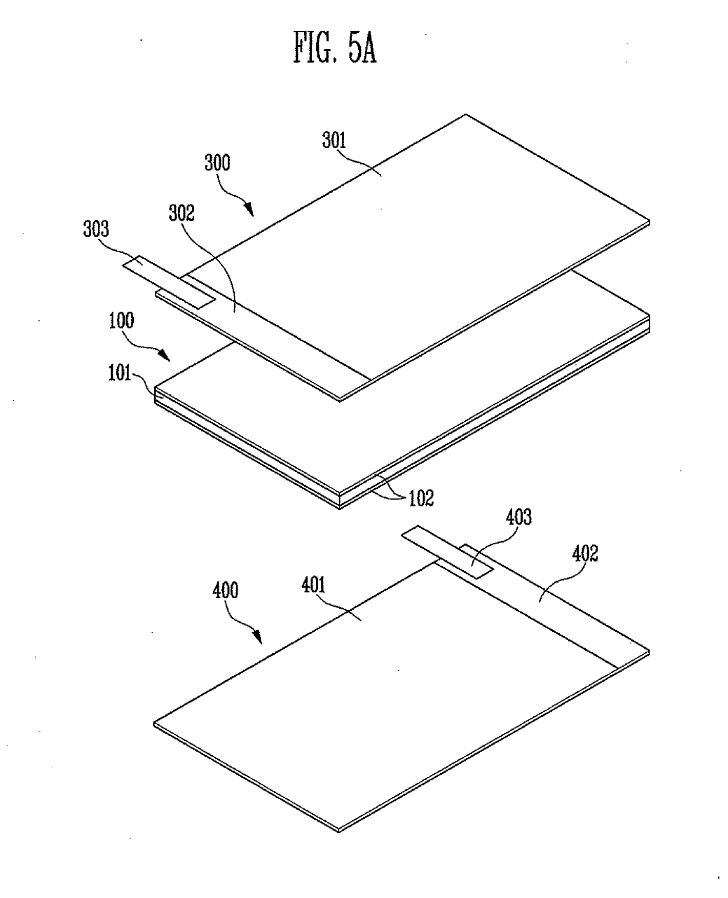

FIG. 3 is a perspective view illustrating a separator according to another embodiment. FIG. 4 is cross-sectional view taken along the line B-B′ of FIG. 3.

Referring to FIGS. 3 and 4, a separator 200 according to another embodiment may include a substrate layer 201 that is porous and adhesion layers 202 on or formed on at least one side (or both sides) of the substrate layer 201. Inorganic substances 203 may be embedded in the separator 200 (e.g., may be embedded inside the substrate layer 201). For example, the inorganic substances 203 may be positioned on both sides of the substrate layer 201, and an inorganic layer 204 where the inorganic substances 203 are embedded may be on or formed on at least one side (or both sides) of the substrate layer 201. For example, the separator 200 may include the inorganic layers 204 on both sides of the substrate layer 201, and the inorganic substances 203 may be embedded in the inorganic layers 204.

The inorganic layer 204 may be formed as additional layers on both sides of the substrate layer 201. In some embodiments, the inorganic substances 203 may also be embedded in the substrate layer 201. For example, in some embodiments, the separator 200 includes the inorganic substances 203 embedded in the inorganic layers 204 and includes additional inorganic substances 203 embedded in the substrate layer 201. The substrate layer 201 may be formed of any one selected from polyethylene, polypropylene, and any mixture thereof, having a first air permeability. The inorganic layers 204 on or formed on both sides of the substrate layer 201 may have a second air permeability that is greater than the first air permeability (e.g., the second air permeability may be larger, in terms of sec/100 cc, than the first air permeability).

It may be more suitable or advantageous for transfer of lithium ions if the inorganic layers 204 are on or formed on both sides of the substrate layer 201 as illustrated in another embodiment (e.g., as illustrated in FIGS. 3 and 4) than if the inorganic substances 103 are mixed inside the substrate layer 101 as illustrated in the first embodiment. As the pore size on the outside (of the substrate layer) becomes greater than the pore size inside the substrate layer 201, lithium ions may be transferred smoothly.

The thickness of the substrate layer 201 (e.g., the porous substrate layer 201) is not greatly restricted, but a suitable or preferable range may be 1 to 14 μm. If the thickness of the substrate layer 201 (e.g., the porous substrate layer 201) is less than 1 μm, it may be difficult to maintain a mechanical property of the substrate layer 201, and also there may be difficulty in implementing a long life characteristic since the pore size is small. If the thickness of the substrate layer 201 (e.g., the porous substrate layer 201) exceeds 14 μm, it may act as a resistance layer (e.g., the resistance of the substrate layer 201 may be too high) since there is no great difference in mechanical strength and heat resisting property compared as with a substrate layer 201 having a thickness that is 14 μm or less. The thickness of the inorganic layer 204 may be formed to be in the range of 1 to 14 μm.

The pore size of the substrate layer 201 (e.g., the porous substrate layer 201) may be in a range of 10 to 65 nm. The pore size of the inorganic layer 204 may be in a range of 65 to 200 nm. The air permeability where the inorganic layers 204 are on or formed on both sides of the substrate layer 201 may have a range of 150 to 300 sec/100 cc. For example, each of the inorganic layers 204 may have an air permeability of 150 to 300 sec/100 cc. If the pore size of the inorganic layer 204 is less than 65 nm, and if the air permeability is formed to have (or to be) less than 150 sec/100 cc, it may be difficult to improve a long life and a heat-resisting property of the substrate layer 201 since it is not greatly different from the substrate layer 201 where the inorganic substances 203 are not embedded. If the pore size of the inorganic layer 204 exceeds 200 nm, and if the air permeability exceeds 300 sec/100 cc, it may be difficult to maintain a mechanical property of the inorganic layer 204, and due to excessively large pores, there may be an increased risk of internal short-circuit at the time of charging/discharging battery.

The adhesion layers 202 on or formed on both sides of the inorganic layer 204 may include or be formed of a porous polymer such as polyvinylidene fluoride (PVDF) and acrylate. For example, a respective one of the adhesion layers 202 may be on each inorganic layer 204, and at least one of the adhesion layers 202 includes the porous polymer (e.g., polyvinylidene fluoride (PVDF) and/or acrylate). The adhesion layers 202 may be, with both sides of the layer included, 1 to 6 μm thick (e.g., the sum of the thicknesses of the adhesion layers 202 may be 1 to 6 μm), and may be capable of not impeding or substantially impeding the air permeability of the separator 200, along with increasing an adhesion of the electrode plates. If the adhesion layers 202 on or formed on both sides of the inorganic layer 204 are formed to be less than 1 μm, an adhesive force with the electrode plates may not be implemented (e.g., an adhesive force of the electrode plates to the inorganic layers 204 may not be improved). If the thickness (e.g., the total thickness) of the adhesion layers 202 on or formed on both sides of the inorganic layer 204 exceed 6 μm, air permeability performance may be impossible to implement (e.g., the air permeability of the separator may not be improved).

Although, in this embodiment, the substrate layer 201 and the inorganic layer 204 are illustrated as separate layers, they may be formed in one body (e.g., a single layer may include the substrate layer 201 and one or more of the inorganic layers 204).

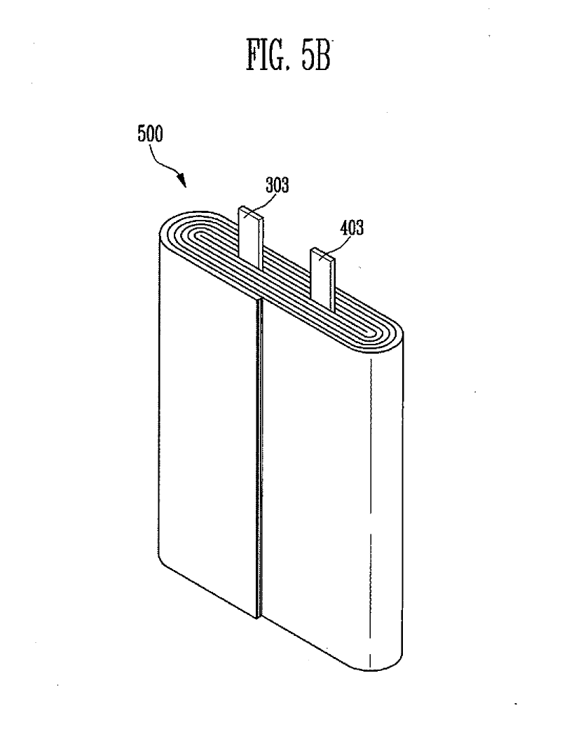

FIG. 5A is an exploded perspective view illustrating an electrode assembly. FIG. 5B is a perspective view illustrating an electrode assembly in a state of being wound (e.g., the electrode assembly in a wound state).

Referring to FIGS. 5A and 5B, an electrode assembly 500 according to an embodiment may include an anode plate 300, a cathode plate 400 and a separator 100. The anode plate 300 may include an anode active layer 301 where anode active material is coated on both sides of an anode collector and a non-anode portion 302. The cathode plate 400 may include a cathode active layer 401 where cathode active material is coated on both sides of a cathode collector and a non-cathode portion 402 where cathode active material is not coated. An anode tab 303 and a cathode tab 403 may be located at the non-anode portion 302 and the non-cathode portion 402, respectively.

A separator 100 may be located between the anode plate 300 and the cathode plate 400 and be winded (e.g., the separator 100, the anode plate 300, and the cathode plate 400 may be wound into a jelly roll form). The separator 100 may mutually insulate between the anode plate 300 and the cathode plate 400. The separator 100 may allow lithium ions to transfer between the anode plate 300 and the cathode plate 400. The separator 100 may preferably have a suitable or sufficient length to completely or substantially completely insulate between the anode plate 300 and the cathode plate 400 even though the electrode assembly 500 (e.g., the separator 100) may contract and expand.

The separator 100 may be porous and may include the substrate layer 101 where inorganic substances are embedded and adhesion layers 102 on or formed on both sides of the substrate layer 101. As the inorganic substances are embedded in the substrate layer 101 of the separator 100, a long life property and a heat-resisting property of the separator 100 may be improved. As the adhesion layers 102 are on or formed on both sides of the substrate layer 101, adhesive force between the anode plate 300 and the cathode plate 400 may be enhanced.

For the anode active material, any suitable lithium transition-metal oxide or lithium chalcogenide compound represented by a metal oxide such as LiCoO₂, LiNiO₂, LiMnO₂, LiMn₂O₄ and/or LiNi_{1-x-y}CoₓM_{y}O₂ (here, 0≦x≦1, 0≦y≦1, 0≦x+y≦1 and M is a metal such as Al, Sr, Mg and La) may be utilized. For the cathode active material, a carbon material such as crystalline carbon, amorphous carbon, carbon complex, and/or carbon fiber, lithium metal or lithium alloy may be used.

The cathode collector and the anode collector may include or be formed of any one selected from stainless steel, nickel, copper, aluminum, and an alloy thereof. For increasing or maximizing efficiency, the anode collector may include or be formed of aluminum or aluminum alloy, and the cathode collector may include or be formed of copper or copper alloy. The substrate layer 101 of the separator 100 may include or be formed of a polyolefin polymer film.

Although the electrode assembly 500 is illustrated as being wound with the separator 100 being interposed between the anode plate 300 and the cathode plate 400, the electrode assembly 500 may be formed to have the separator 100 being interposed between the anode plate 300 and the cathode plate 400, and being stacked in a plurality of layers.

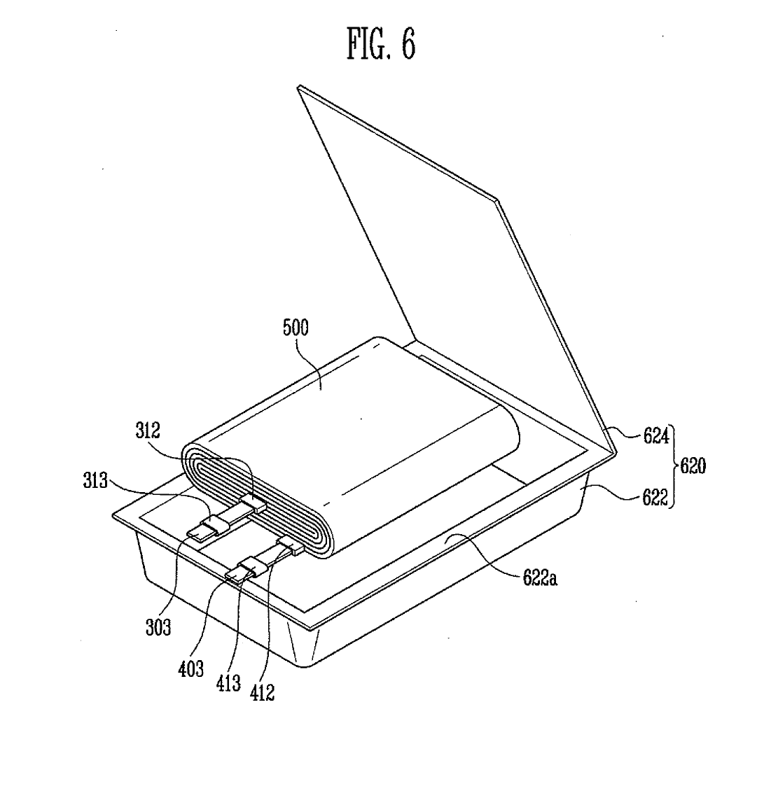

FIG. 6 is a perspective view illustrating a secondary battery.

Referring to FIG. 6, an electrode assembly 500 may be received in a receiving portion 622 of a pouch case 620. A cover portion 624 on or formed on one side of the receiving portion 622 may be folded. A part 622a where the receiving portion 622 and the cover portion 624 are in contact may be sealed.

The electrode assembly 500 received inside the pouch case 620 may be formed by the separator 100 being interposed between the anode plate 300 and the cathode plate 400 and then winding (e.g., being winded). An anode tab 303 may protrude to an upper part of the electrode assembly by being coupled to the anode plate 300. A cathode tab 403 may protrude to the upper part of the electrode assembly 500 by being coupled to the cathode plate 400. In the electrode assembly 500, the anode tab 303 and the cathode tab 403 may be electrically insulated by being spaced apart by a predetermined or set length.

There may be lamination tapes 312 and 412 wound where the anode tab 303 and the cathode tab 403 are withdrawn from the electrode assembly 500 (e.g., the lamination tape 312 may be wound around a portion of the anode tab 303 that is adjacent to, and protrudes from, the electrode assembly 500, and the lamination tape 412 may be wound around a portion of the cathode tab 403 that is adjacent to, and protrudes from, the electrode assembly 500). The lamination tapes 312 and 412 may block or reduce generation of heat from the anode tab 303 or the cathode tab 403 and prevent the electrode assembly 500 from being pressurized by edges of the anode tab 303 or the cathode tab 403 (or may reduce such pressurization).

There may also be insulating tapes 313 and 413 attached on (e.g., wound around) surfaces where the anode tab 303 and the cathode tab 403 come into contact with the pouch case 620 and the insulating tapes 313 and 413 may be installed to partially protrude to outside of the pouch case 620.

The embodiments and comparison examples below are provided to describe embodiments of the present disclosure in a clear manner. However, the embodiments are for illustrative purposes only and the subject matter of the present disclosure should not be limited thereto.

Table 1 below compares properties of a secondary battery according to a change in the materials of the substrate layer and adhesion layers of the separator. In each characteristic evaluation, if the applicable property was met (e.g., if the property evaluated was suitable), SPEC OK is inserted in Table 1 for that property, and if the applicable property was not met (e.g., if the property evaluated was unsuitable), NG is inserted in Table 1 for that property. If the substrate layer of the separator includes or is formed of the inorganic substance embedded layer/polyethylene/inorganic substance embedded layer, the pore size of the polyethylene is 50 to 60 nm and the thickness of the substrate layer is 8 μm. The pore size of the inorganic substance embedded layer is 65 to 200 nm and thickness is 8 μm. The sum of the thicknesses of the adhesion layers on (formed on) both sides of the inorganic substance embedded layer is 5 μm.

TABLE 1

| | | | | 130° C. | | Colli- |
|---|---|---|---|---|---|---|
| | Substrate | Adhe- | Life | heat | Pass | sion |
| | layer | sion | of 700 | exposure | through | prop- |
| Category | composition | layer | cycles | property | property | erty |
| Embod- | Inorganic | acryl | 85% | SPEC | SPEC | SPEC |
| iment1 | substance | | of the | OK | OK | OK |
| | embedded | | initial | | | |
| | layer/ | | capacity | | | |
| | PE/inorganic | | | | | |
| | substance | | | | | |
| | embedded | | | | | |
| | layer | | | | | |
| Embod- | Inorganic | PVdF | 80% | SPEC | SPEC | SPEC |
| iment 2 | substance | | of the | OK | OK | OK |
| | embedded | | initial | | | |
| | layer/PE/ | | capacity | | | |
| | inorganic | | | | | |
| | substance | | | | | |
| | embedded | | | | | |
| | layer | | | | | |
| Embod- | Inorganic | acryl | 90% | SPEC | SPEC | SPEC |
| iment 3 | substance | | of the | OK | OK | OK |
| | embedded | | initial | | | |
| | layer | | capacity | | | |
| Com- | Regular PE | acryl | 50% | SPEC | NG | NG |
| parison | | | of the | OK | | |
| Example 1 | | | initial | | | |
| | | | capacity | | | |

In Embodiment 1, the substrate layer is formed of (includes) inorganic substance embedded layer/polyethylene/inorganic substance embedded layer, and the adhesion layers are formed of (include) acryl type (or kind). Here, life characteristic is shown as 85% of the initial capacity, and heat exposure, pass through and collision properties are all suitable or satisfactory.

In Embodiment 2, the substrate layer is formed of (includes) inorganic substance embedded layer/polyethylene/inorganic substance embedded layer, and the adhesion layers are formed of (include) PVdF. Here, life characteristic is shown as 80% of the initial capacity, and heat exposure, pass through and collision properties are all suitable or satisfactory. Although the life characteristic is not as good as the one in Embodiment 1, it meets the long life characteristic (the long life characteristic of Embodiment 2 is suitable).

In Embodiment 3, the substrate layer is formed of (includes) inorganic substance embedded layer, and the adhesion layers are formed of (include) acryl type (or kind). Here, life characteristic is shown as 90% of the initial capacity, showing the most excellent long life characteristic, and heat exposure, pass though and collision properties are all suitable or satisfactory.

In Comparison Example 1, the substrate layer is formed of (includes) polyethylene, and the adhesion layers are formed of (include) acryl type (or kind). Here, the life characteristic is shown only as 50% of the initial capacity, and heat exposure characteristic is suitable or satisfactory, but pass through and collision properties are unsuitable or not satisfactory.

As inorganic substances are embedded in the substrate layer of the separator, various properties may be enhanced which are demanded in a secondary battery rather than using a substrate layer that is formed of polyethylene. For example, long life and collision and pass through properties are improved.

Example embodiments have been disclosed herein, and although specific terms are employed, they are used and are to be interpreted in a generic and descriptive sense only and not for purpose of limitation. In some instances, as would be apparent to one of ordinary skill in the art at the time of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims, and equivalents thereof.

What is claimed is:

1. A separator comprising:
a substrate layer that is porous; and
an adhesion layer on at least one side of the substrate layer,
wherein inorganic substances are embedded in the separator.

2. The separator as claimed in claim 1, wherein the inorganic substances are located inside the substrate layer.

3. The separator as claimed in claim 1, further comprising inorganic layers on both sides of the substrate layer,
wherein the inorganic substances are embedded in the inorganic layers.

4. The separator as claimed in claim 1, wherein the substrate layer comprises any one selected from the group consisting of polyethylene (PE), polypropylene (PP), and a mixture thereof.

5. The separator as claimed in claim 1, wherein the inorganic substances are embedded in the substrate layer, and pores of the substrate layer where the inorganic substances are embedded have a size in a range of 10 to 200 nm.

6. The separator as claimed in claim 1, wherein an air permeability of the separator is in a range of 150 to 300 sec/100 cc.

7. The separator as claimed in claim 1, wherein the adhesion layer comprises a polymer.

8. The separator as claimed in claim 7, wherein the polymer comprises polyvinylidene fluoride (PVDF) or acrylate.

9. The separator as claimed in claim 1, wherein the adhesion layer comprises adhesion layers on both sides of the substrate layer, and
wherein a sum of thicknesses of the adhesion layers on both sides of the substrate layer is in a range of 1 to 6 μm.

10. A secondary battery comprising:
an electrode assembly comprising a first electrode plate, a second electrode plate, and a separator between the first electrode plate and the second electrode plate, the first electrode plate, the second electrode plate and the separator being stacked, and at least one electrode tab being withdrawn to a side of the electrode assembly; and
a case receiving the electrode assembly,
wherein the separator is porous, inorganic substances are embedded in the separator, and the separator comprises a substrate layer comprising an adhesion layer on at least one side of the substrate layer.

11. The secondary battery as claimed in claim 10, wherein the inorganic substances are located inside the substrate layer.

12. The secondary battery as claimed in claim 10, the separator further comprising inorganic layers on both sides of the substrate layer, wherein the inorganic substances are embedded in the inorganic layers.
